(19) United States
(12) Patent Application Publication
(10) Pub. No.: US 2007/0070637 A1
(43) Pub. Date: Mar. 29, 2007

(54) OPTICAL MACHINE HAVING LIGHT PIPE WITH ROTATIONAL DEGREES OF FREEDOM

(76) Inventor: Shih-Hung Yu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/534,671

(22) Filed: Sep. 24, 2006

(30) Foreign Application Priority Data
Sep. 26, 2005 (TW) 094133359

(51) Int. Cl. F21V 19/00

(52) U.S. Cl. 362/382

(57) ABSTRACT

An optical machine includes a light pipe, a light pipe holder, and a light pipe covering installed on the light pipe holder in a rotatable manner for covering the light pipe. The optical machine utilizes a hinge connection of the light pipe covering and the light pipe holder so as to provide degrees of freedom of rotation and limit degrees of freedom of translation.

### BACKGROUND OF THE INVENTION

1. Field of the Invention

The present invention relates to an optical machine, and more particularly, to an optical machine having a light pipe that has rotational degrees of freedom.

2. Description of the Prior Art

Projectors are conventionally used in conference briefings in which a host projects data or graphics onto a screen for familiarizing attendants with a presentation. With the rapid development of technology, projectors have been widely used in other applications. With high-power hi-fi equipment, large-capacity digital video discs (DVDs), and large images generated by a projector, it is now possible to reconstruct at home visual and audio effects similar to those provided in a movie theater.

An optical machine is a very important component of a projector. In an optical machine with an adjustable light pipe, an angle of light emitting to the light pipe is adjusted by turning a screw. Please refer to FIG. 1. FIG. 1 is a perspective drawing of an optical machine 10 in the prior art. The optical machine 10 includes a light pipe 12, a light pipe covering 14 for covering the light pipe 12 so as to protect the light pipe 12, a light pipe holder 16 for supporting the light pipe covering 14, and two screws 18a, 18b. A user can turn the two screws 18a, 18b to push the light pipe covering 14 to adjust a position of the light pipe 12. When the user turns the screw 18a, the light pipe covering 14 can be moved in the X-Z plane so as to adjust the position of the light pipe 12 in the X-Z plane. When the user turns the screw 18b, the light pipe covering 14 can be moved in the X-Y plane so as to adjust the position of the light pipe 12 in the X-Y plane. However, during the adjusting process, it is easy for the light pipe 12 to be moved in the Z direction so that the light route becomes biased due to a bias of the light pipe 12, resulting in decreased quality.

### SUMMARY OF THE INVENTION

It is therefore a primary objective of the claimed invention to provide an optical machine for solving the above-mentioned problem.

According to claimed invention, an optical machine includes a light pipe, a light pipe holder, and a light pipe covering installed on the light pipe holder in a rotatable manner for covering the light pipe.

These and other objectives of the present invention will no doubt become obvious to those of ordinary skill in the art after reading the following detailed description of the embodiment that is illustrated in the various figures and drawings.

### BRIEF DESCRIPTION OF THE DRAWING

FIG. 1 is a perspective drawing of an optical machine in the prior art.

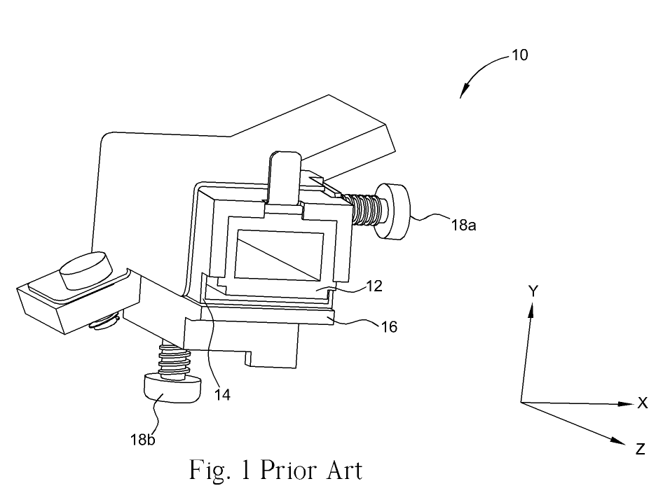

FIG. 2 is an exploded diagram of an optical machine according to the present invention.

FIG. 3 is a perspective drawing of the optical machine according to the present invention.

FIG. 4 is a X-Y projection of a spherical structure installed inside a spherical cavity according to the present invention.

FIG. 5 is a Y-Z projection of the spherical structure installed inside the spherical cavity according to the present invention.

### DETAILED DESCRIPTION

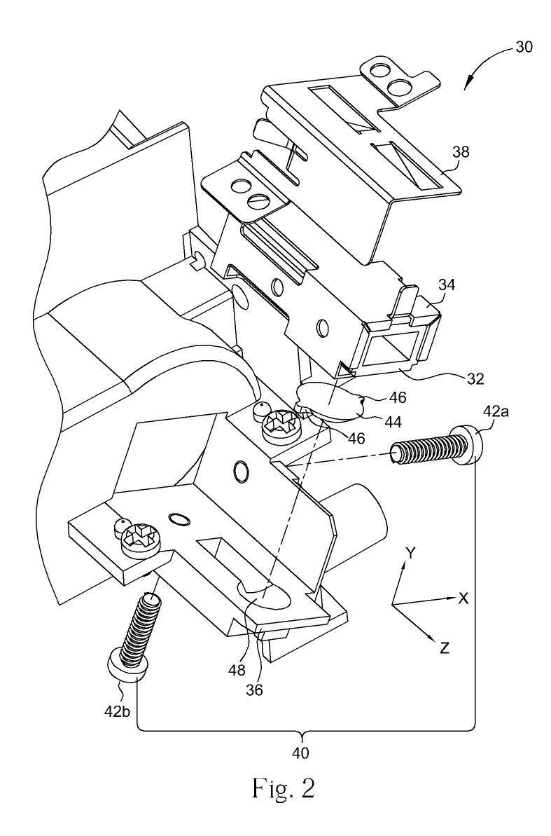

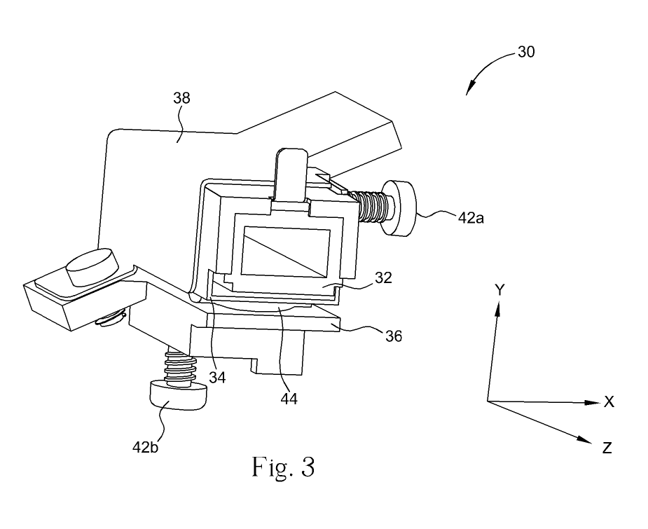

Please refer to FIG. 2 and FIG. 3. FIG. 2 is an exploded diagram of an optical machine 30 according to the present invention. FIG. 3 is a perspective drawing of the optical machine 30 according to the present invention. The optical machine 30 is utilized in a projector. The optical machine 30 includes a light pipe 32; a light pipe covering 34, which can be made of steel or a metal plate, for covering the light pipe 32 so as to protect the light pipe 32 from damage or overheating; a light pipe holder 36 for supporting the light pipe 32 covered by the light pipe covering 34; a clip 38 and the light pipe holder 36 for clipping the light pipe 32 covered by the light pipe covering 34 together; and a light pipe adjusting mechanism 40 for pushing the light pipe covering 34 so as to adjust a position of the light pipe 32. The light pipe adjusting mechanism 40 includes two screws 42a, 42b.

The optical machine 30 further includes a spherical structure 44. The spherical structure 44 can be made of plastic material and connected below the light pipe covering 34 or can be formed by stamping the light pipe covering 34 so as to connect to the light pipe covering 34 in a monolithic structure. The spherical structure 44 includes two flanges 46 protruding on two sides of the spherical structure 44. Each of the two flanges 46 can be of a fillet structure (i.e., rounded). The light pipe holder 36 includes a spherical cavity 48, and the spherical structure 44 is installed inside the spherical cavity 48 in a rotatable manner. That is, when the light pipe 32 covered with the light pipe covering 34 is adjusted by the light pipe adjusting mechanism 40, the spherical structure 44 rotates inside the spherical cavity 48 for adjusting an angle of the light pipe 32.

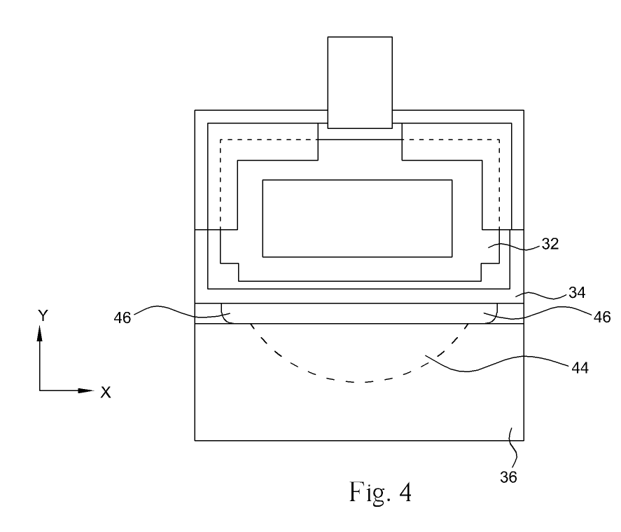

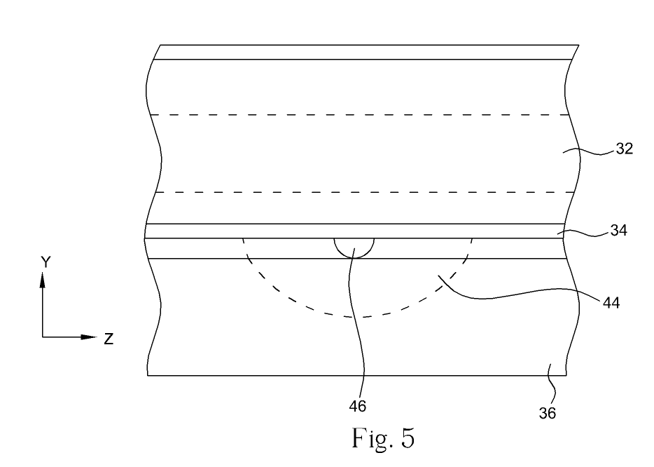

Please refer to FIG. 4 and FIG. 5. FIG. 4 is a X-Y projection of the spherical structure 44 installed inside the spherical cavity 48 according to the present invention. FIG. 5 is a Y-Z projection of the spherical structure 44 installed inside the spherical cavity 48 according to the present invention. Because the two flanges 46 of the spherical structure 44 stop the light pipe holder 36, the spherical structure 44 can not rotate in the X-Y plane, that is, the spherical structure 44 can not roll in the Z direction as shown in FIG. 2. The light exit plane of the light pipe 32 will not be biased so that the image projecting from a projector onto a screen will not be biased. As shown in FIG. 2 and FIG. 5, the connection of the spherical structure 44 and the spherical cavity 48 is similar to a hinge connection and the flanges 46 have fillet structures. When a user turns the screw 42b for pushing the spherical structure 44 to rotate in the Y-Z plane, the spherical structure 44 rotates about the X axis as shown in FIG. 2, the light pipe 32 covered by the light pipe covering 34 rotating in the Y-Z plane relative to a joint of the spherical structure 44 and the spherical cavity 48 as a pivot. In addition, when the user turns the screw 42a for pushing the spherical structure 44 to rotate in the X-Z plane, the spherical structure 44 rotates about the Y axis as shown in FIG. 2, the light pipe 32 covered by the light pipe covering 34 rotating in the X-Z plane relative to a joint of the spherical structure 44 and the spherical cavity 48 as a pivot.

In conclusion, the light pipe covering 34 covers the light pipe 32 and the spherical structure 44 is connected to the bottom of the light pipe covering 34. When the spherical structure 44 rotates inside the spherical cavity 48, the light pipe 32 rotates relative to the joint of the spherical structure 44 and spherical cavity 48 as a pivot. The combination of the light pipe holder 34 and the spherical structure 44 is limited to be inside the spherical cavity 48, so the light pipe 32 can not be moved in the Z direction. This can ensure the light pipe 32 is positioned in a best location, and is preferable to adding additional constraints for limiting the movement of the light pipe 32 in the Z direction.

Furthermore, the combination of the spherical structure and the spherical cavity is not limited to the above-mentioned embodiment. Any other mechanism for providing degrees of freedom of rotation and limiting degrees of freedom of translation of the light pipe, such as a hinge connection, is within the scope of the present invention.

In contrast to the conventional optical machine, the optical machine according to the present invention utilizes the hinge connection of the light pipe covering and the light pipe holder so as to provide degrees of freedom of rotation and limit degrees of freedom of translation of the light pipe. This can ensure the light pipe is positioned in a best location, and the yield rate of manufacture and the quality of the projector will increase.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical machine comprising:
a light pipe;
a light pipe holder; and
a light pipe covering installed on the light pipe holder in a rotatable manner for covering the light pipe.

2. The optical machine of claim 1 wherein the light pipe holder comprises a spherical cavity and the light pipe covering comprises a spherical structure installed inside the spherical cavity in a rotatable manner.

3. The optical machine of claim 2 wherein the spherical structure is installed partly inside the spherical cavity and the spherical structure comprises two flanges for limiting the spherical structure to rotate inside the spherical cavity in a first rotation dimension.

4. The optical machine of claim 3 wherein the two flanges have fillet structures.

5. The optical machine of claim 2 wherein the spherical structure is formed by stamping the light pipe covering.

6. The optical machine of claim 2 wherein the spherical structure is made of plastic material.

7. The optical machine of claim 2 further comprising a light pipe adjusting mechanism for pushing the light pipe covering to drive the spherical structure to rotate inside the spherical cavity so as to adjust a position of the light pipe covering inside the light pipe holder.

8. The optical machine of claim 7 wherein the light pipe adjusting mechanism comprises a screw.

9. The optical machine of claim 1 wherein the light pipe covering is made of steel.
